(19) United States
(12) Patent Application Publication
(10) Pub. No.: US 2005/0165618 A1
(43) Pub. Date: Jul. 28, 2005

(54) Assessment of a physical exercise facility

(76) Inventor: Arnold P. Nerenberg, Whittier, CA (US)

Correspondence Address: ARLEN L. OLSEN;SCHMEISER, OLSEN & WATTS, 3 LEAR JET LANE, SUITE 201, LATHAM, NY, 12110, US

(21) Appl. No.: 10/767,527

(22) Filed: Jan. 22, 2004

(51) Int. Cl. G06F 17/60

(52) U.S. Cl. 705/1

(57) ABSTRACT

A method and system for assessing a physical exercise facility. An inspection team including at least one inspector inspects the facility through at least one on-site inspection of the facility. The organization rates the facility using a plurality of rating factors derived from the at least one on-site inspection. The rating factors may include healthfulness, comradery, competence, equipment, products, and services.

### BACKGROUND OF THE INVENTION

1. Technical Field

The present invention relates to a method and system for assessing a physical exercise facility.

2. Related Art

Current gymnasiums, health clubs, and other physical exercise facilities provide a wide range of physical exercise equipment and physical training services to the general public. In choosing such a physical exercise facility, however, one generally does not have the availability of objective information as to how good (or bad) various physical exercise facilities are. Thus, an individual typically chooses a physical exercise facility based on insufficient information, and the choice may therefore not be a good choice for the individual.

Accordingly, there is a need for an objective method and system for assessing a physical exercise facility based on rating factors that are important to a person in choosing a physical exercise facility for achieving the person's exercise, training, and health objectives.

### SUMMARY OF THE INVENTION

The present invention provides a method for assessing a physical exercise facility, comprising the steps of:
inspecting the facility by at least one inspector through at least one on-site inspection of the facility by the at least one inspector; and
rating the facility using a plurality of rating factors derived from the at least one on-site inspection.

The present invention provides a system for assessing a physical exercise facility, comprising:
an inspection team including at least one inspector, said team adapted to inspect the facility through at least one on-site inspection of the facility by the at least one inspector; and
an organization adapted to rate the facility using a plurality of rating factors derived from the at least one on-site inspection.

The present invention advantageously provides an objective method and system for assessing a physical exercise facility based on rating factors that are important to a person in choosing a physical exercise facility for achieving exercise, training, and health objectives of the person.

### BRIEF DESCRIPTION OF THE DRAWINGS

FIG. 1 is a flow chart depicting steps of a method for assessing a physical exercise facility, in accordance with embodiments of the present invention.

FIG. 2 depicts a system for assessing the physical exercise facility in accordance with the method of FIG. 1.

FIG. 3 is a table that lists rating factors that may be used for assessing the physical exercise facility by the method of FIG. 1, in accordance with embodiments of the present invention.

### DETAILED DESCRIPTION OF THE INVENTION

The present invention discloses methodology for assessing a physical exercise facility with respect to factors that are important to persons in choosing a physical exercise facility to utilize for achieving their objectives with respect to exercise, training, body building, strength, and health. A physical exercise facility is a facility that provides exercise equipment and trainers for enabling users of the facility to achieve their exercise, training, body building, strength, and health objectives. The scope of the present invention includes a wide variety of different types of physical exercise facilities including, inter alia, gymnasiums, health clubs, etc. Some physical exercise facilities generally support many different objectives; e.g., health clubs. Other physical exercise facilities specialize in particular areas and include, inter alia, power lifting gymnasiums, body building gymnasiums, cardiovascular conditioning gymnasiums, boxing clubs, wrestling clubs, martial arts gymnasiums, etc.

A user of the facility is defined as a person who exercises at the facility using the exercise equipment of the facility, wherein the person is not employed by the facility. Examples of a user of the facility include a customer of the facility, a non-staff member of the facility (e.g., a member of a health club).

A facility trainer is defined as a staff member whose job includes assisting and guiding the users in helping the users to formulate and achieve exercise and health goals in connection with using the facility. A facility trainer teaches the user how to use the exercise equipment, explains human physiology and nutrition to the user in relation to body building, power lifting, and cardiovascular health, suggests realistic timetables for achieving goals, etc.

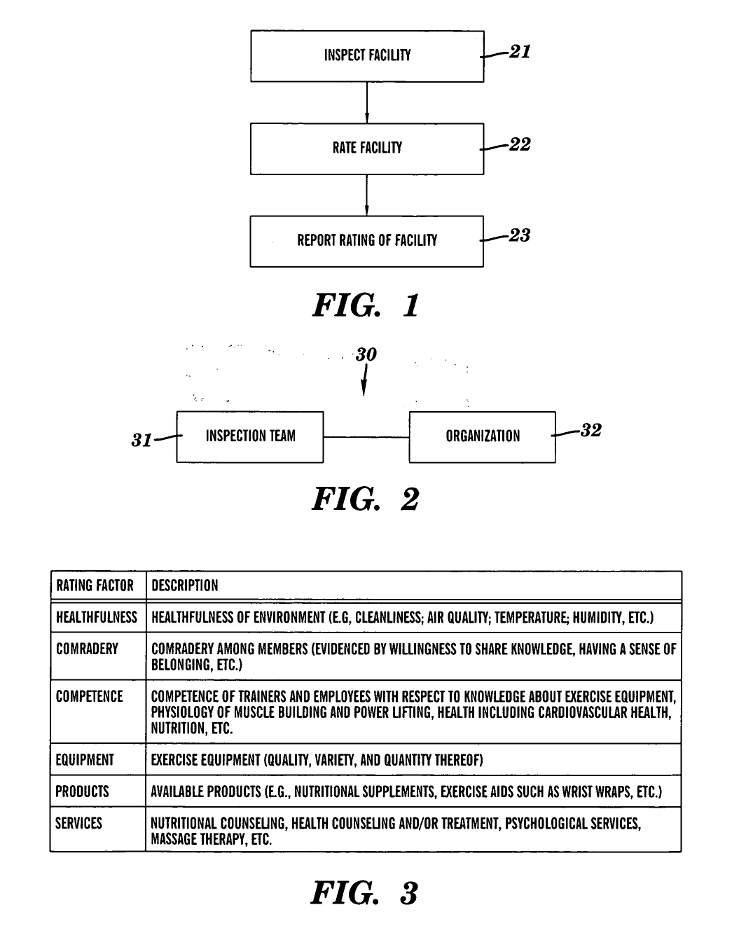

FIG. 1 is a flow chart depicting steps 21-23 of a method for assessing a physical exercise facility, in accordance with embodiments of the present invention. The method comprises inspecting the physical exercise facility (step 21), rating the physical exercise facility(step 22), and publishing the rating of the physical exercise facility (step 23). An example of publishing the rating includes posting the rating at the physical exercise facility.

FIG. 2 depicts a system 30 for assessing the physical exercise facility in accordance with the method of FIG. 1. The system 30 comprises an inspection team 31 that performs the inspection step 21 and an organization 32 that performs the rating step 22. The inspection team 31 comprises at least one inspector (e.g., a plurality of inspectors). The organization 32 rates the facility and certifies the rating. The organization 32 may any business entity, charitable organization, nonprofit organization, governmental entity, etc. The organization 32 may have any of several types of relationships with the inspection team 31. For example, the inspection team 31 may be employed by the organization 32, may be an independent contractor of the organization 32, may be the owner(s) of the organization 32, or may be employees or independent contractors of another organization the has a contractual arrangement with the organization 32 to perform the required inspection of the physical exercise facility.

In step 21, the inspection team 31 of at least one inspector perform at least one on-site inspection of the facility. The at least one on-site inspection: may be scheduled in advance of the inspection, may be unscheduled and constitute an unannounced surprise visit to the facility, or may be a combination of scheduled and unscheduled visits. In connection with an unscheduled surprise visit to the facility, the inspectors may pose as users of the exercise facility so as to be able to observe the facility and the typical behavior of facility users and facility staff (e.g., facility trainers) without the facility users and staff having knowledge that an inspection is occurring. This concealing of the identity of the visitors as inspectors reduces a probability of the facility users and staff behaving atypically during the inspection. This concealing of the identity of the visitors also enhances the accuracy and usefulness of the rating that will subsequently result from the information collected by the inspectors during the inspection. Alternatively, the inspector(s) could inform the users and staff of their identity as inspector(s).

The ability of the inspector(s) to implement the on-site inspection will typically result from a contract between the facility and the organization 32 of FIG. 2 that is to rate the facility and certify the rating. For example, the facility may agree to pay the organization 32 of FIG. 2 a specified sum of money in return for being rated by the organization 32. Alternatively, the inspections of the facility may not involve such a contract. For example, the inspectors may be paid members or customers of the facility and perform the inspection(s) with or without the facility's knowledge. However, the inspectors should not perform the inspection(s) without the facility's knowledge if doing so is illegal or breaks a rule of the facility that members and customers of the facility are expected to adhere to.

The team of inspectors may comprise, inter alia, a male inspector, a plurality of male inspectors, a female inspector, a plurality of female inspectors, a male inspector and a female inspector, etc. One or more inspectors of the at least one inspector may be a trained inspector that has taken a training course pertinent to performing said inspecting. The training course may be sponsored by the organization 32 of FIG. 2 that performs the rating in step 22, or by an other recognized organization that provides such ratings. The inspector satisfies minimum standards of experience and knowledge of power lifting, body building, and health, and the inspector has passed an examination that tests knowledge of physical training, health, and the dynamics of comradery. The inspector has competence in performing power lifting and body building, and has sufficient knowledge of health to adequately advise users of the facility as to health matters relating to exercising, power lifting, body building, etc. The inspector is physically fit, has a physically fit appearance, and has passed a minimum strength test. The minimum strength requirement may be a function of the age and weight of the user. The inspector may have belonged to at least N entities having a physical exercise facility, wherein the at least one trained inspector has exercised in the physical exercise facility of each said entity, and wherein N is at least 2 and may have any integer value exceeding 2 such as 3, 4, 5, 6, etc. The inspector should engage in continuing education in order to meet minimum continuing education requirements, and the inspector should be re-certified periodically (e.g., every two or three years).

During the inspection of the facility, the inspectors collect information relevant to the rating of the facility in step 22 of the method of FIG. 1. In step 22, performing the rating of the physical exercise facility comprises using a plurality of rating factors derived from the at least one on-site inspection. FIG. 3 is a table that lists rating factors which may be used for assessing the physical exercise facility by the method of FIG. 1, in accordance with embodiments of the present invention. The rating factors in FIG. 3 are: healthfulness, comradery, competence, equipment, products, and services.

The rating factor of healthfulness pertains to healthfulness of the environment of the facility, which includes cleanliness, air quality, temperature, and humidity. Cleanliness pertains to cleanliness of all rooms available to users (including locker rooms and bathrooms), all floors, equipment, mirrors, etc. Air quality pertains to air-borne pollutants and dust. Temperature pertains to having a comfortable temperature for exercising and requires adequate heating and air conditioning. Humidity pertains to having a comfortable relative humidity for exercising and requires adequate humidity control equipment to ensure that the air is neither too moist nor too dry. The inspectors may collect information about the healthfulness of the environment during the on-site inspection by personal observation and/or by use of instrumentation to measure environmental parameters (e.g., thermometer, humidity measurement device, device that tests air samples for dust and pollutants, etc.).

The rating factor of comradery pertains to comradery experienced by users of the facility. Comradery is evidenced by willingness to share knowledge, having a sense of belonging, etc. The inspectors may collect information about comradery during the on-site inspection by personal observation, such as by observing whether users are: greeting each other when they walk into the exercise room; helping each other; spotting for another user who is lifting weights which may be too heavy for the another user; enhancing the confidence of a user who is attempting to overcome a very difficult challenge (e.g., expressing “you can do it, you can do it!” to the user); being supportive to a user who did not quite achieve his or her objective (e.g., expressing “its OK—you will make it next time!”). The inspector may also ask users whether they feel a sense of comradery in the gym and whether they have the feeling of “belonging”. An absence of comradery is evidenced by an absence of supportive interactions among the users, such as may be observed by the inspectors whereby the users use exercise equipment independently with almost no communication between or among the users. The inspectors may also assess the existence or absence of comradery by observing interactions (or absence thereof) between users and facility staff (e.g., facility trainers). Comradery among users is facilitated by trainers who are supportive, helpful, and friendly to users. Additionally, the inspectors may interview the users to ask question relating to comradery and requesting the users to describe their experiences relating to comradery or absence thereof.

The rating factor of competence pertains to the competence of facility trainers and other employees with respect to their knowledge about exercise equipment, physiology of muscle building and power lifting, health including cardiovascular health, nutrition, etc. The inspectors may collect information about the competence of facility trainers during the on-site inspection by personal observation of the use of the exercise equipment by the trainers and interaction between the trainers and the users. Additionally, the inspectors may interview the trainers to test the trainers as to their competence. The inspectors may also test the trainers by written examination. In addition, the inspectors may interview the users to receive feedback from the users as to their impression of the competence of the trainers.

The rating factor of equipment pertains to the quality, quantity, and variety of the exercise equipment (including exercise machines and/or free weights) in the facility. The quality relates to the durability, functionality, and condition of the equipment. The quantity pertains to the sufficiency of the number of exercise machines and other exercise equipment (e.g., free weights) in relation to the average and maximum number of users of the equipment during any period of time. For example, the inspectors may probe as to whether the users have available equipment at their disposal when they are ready to use the equipment, or whether the users have to wait an unreasonable amount of time until others have finished using the equipment. The variety of the equipment relates to the need for sufficient variety to accommodate all exercise objectives of a user. For example, a body builder needs sufficient variety in exercise machines and/or free weights to exercise all of the muscles which the user intends to develop. The inspectors may collect information about the equipment during the on-site inspection by personal observation, inspection, and usage of the equipment The inspectors may also interview the users to obtain their feedback as to the quality, quantity, and variety of the exercise equipment The rating factor of products pertains to the availability of pertinent products for home use and/or use at the facility (e.g., nutritional supplements such as vitamins, minerals, and proteins; exercise aids such as wrist wraps; etc.) in order to further support the exercise, training, and health objectives of the users. It is desirable for such products to be supplied by the facility. Alternatively and/or additionally, the facility may direct users to convenient locations or sources to obtain the products. The inspectors may collect information about the availability of products during the on-site inspection by: personal observation, interview of users, and interview of facility staff (e.g., trainers).

The rating factor of services pertains to the availability of pertinent services to further support the exercise, training, and health objectives of the users. Such pertinent services may include, inter alia, nutritional counseling such by nutritionists, health counseling and/or treatment such as by health practitioners (e.g., chiropractors, holistic health physicians, nurses, macrobiotics counselors, etc.), psychological services such as by clinical psychologists, massage therapists, etc.

The preceding description of the rating factors is based solely on data derived from the on-site visits of the physical exercise facility by the inspectors, so that the rating step 22 therefore is likewise based solely on data derived from the on-site visits of the physical exercise facility by the inspectors. Thus, the rating factors do not take into account any information that is not derived from the at least one on-site inspection. In some embodiments, however, the rating step 22 may take into account some information that is not derived from the at least one on-site inspection, in addition to the information that is derived solely from the at least one on-site inspection.

The rating step 22 of FIG. 1 assigns a rating in terms of a numerical score for each of the rating factors, wherein the rating factors include at least two of the rating factors discussed supra, namely healthfulness, comradery, competence, equipment, products, and services. The numerical score of the rating factors may be in accordance with any numerical scale such as, 20 inter alia, a scale from 1 to 5, wherein “5” represents the best and most favorable score and “1” represents the worst and least favorable score.

The numerical score for each rating factor is a function of the information collected by the inspectors for each rating factor during the on-site inspection of the facility by the at least one inspector. The numerical score may be determined from said information such as by: assigning a numerical weight to each of the various data of the information and synthesizing said numerical weights into said numerical score; using judgment to arrive at said numerical score from said information; or combining said assigning with said using judgement. The numerical score may be determined or computed by the at least one inspector or by others in the organization 32 that formally rates the facility.

The rating step 22 may include generating an overall rating for the facility, wherein the overall rating is a function of the numerical scores of the individual rating factors. The overall rating may be an unweighted arithmetic average of the numerical scores of the individual rating factors. Alternatively, the overall rating may be a weighted arithmetic average of the numerical scores of the individual rating factors. If the rating factors include comradery, then said comradery may have a higher weight than any other rating factor. Generally, the overall rating may be any function of the individual rating factors, such as the root-mean-square of the individual rating factors.

The numerical value V of the overall rating may be converted to a letter rating by any conversion algorithm. For example, if the overall rating has a numerical value between I and 5, then said numerical value may be converted to a letter rating of A, B, or C as follows: 4≦V≦5 (A); 3≦V≦4 (B); and 1≦V≦3 (C).

The publishing step 23 of FIG. 1 comprises reporting the overall rating of the physical exercise facility, and may also comprise publishing the numerical score of each of the rating factors. The facility will be informed of the overall and individual ratings, and the facility may publish the ratings by any method such as advertising the ratings (assuming that the ratings are favorable) in order to promote the facility. Additionally, the organization 32 that determined and certified the ratings may publish the ratings on such media as, inter alia, an Internet website of the organization 32 or any other Internet website, a newsletter published by the organization 32, etc.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

1. A method for assessing a physical exercise facility, comprising the steps of:
inspecting the facility by at least one inspector through at least one on-site inspection of the facility by the at least one inspector; and
rating the facility using a plurality of rating factors derived from the at least one on-site inspection.

2. The method of claim 1, wherein the rating factors include comradery experienced by users of the facility.

3. The method of claim 2, wherein the rating factors further include healthfulness of the environment of the facility, competence of trainers utilized by the facility for assisting and guiding the users, and quality, quantity, and variety of exercise equipment available to the users.

4. The method of claim 3, wherein the rating factors further include availability of products and services supplied by the facility for use by the users in support of at least one of exercise and health goals of the users.

5. The method of claim 1, wherein the rating step includes generating an overall rating for the facility, and wherein the overall rating is a function of the rating factors.

6. The method of claim 5, further comprising publishing the overall rating.

7. The method of claim 6, further comprising publishing the rating factors.

8. The method of claim 6, wherein publishing the overall rating includes publishing the overall rating on an Internet website.

9. The method of claim 8, wherein the Internet website is owned or controlled by an organization that performs the rating step.

10. The method of claim 5, wherein the overall rating is an unweighted arithmetic average of the rating factors.

11. The method of claim 5, wherein the overall rating is a weighted arithmetic average of the rating factors.

12. The method of claim 11, wherein the rating factors include comradery experienced by users of the facility, and wherein said comradery has a higher weight than any other rating factor utilized for generating said overall rating.

13. The method of claim 1, wherein the at least one on-site inspection consists of a plurality of on-site inspections.

14. The method of claim 1, wherein the at least one on-site inspection includes an unscheduled inspection by the at least one inspector.

15. The method of claim 1, wherein the at least one inspector consists of a plurality of inspectors.

16. The method of claim 15, wherein the plurality of inspectors includes a male inspector and a female inspector.

17. The method of claim 1, wherein the at least one inspector has taken a training course pertinent to performing said inspecting.

18. The method of claim 17, wherein the training course was sponsored by an organization that performs the rating step.

19. The method of claim 1, wherein the at least one inspector has passed an examination that tests knowledge of physical exercise, health, and dynamics of comradery.

20. The method of claim 1, wherein the at least one trained inspector is physically fit, has a physically fit appearance, and has passed a minimum strength test.

21. A system for assessing a physical exercise facility, comprising:
an inspection team including at least one inspector, said team adapted to inspect the facility through at least one on-site inspection of the facility by the at least one inspector; and
an organization adapted to rate the facility using a plurality of rating factors derived from the at least one on-site inspection.

22. The system of claim 21, wherein the rating factors include comradery experienced by users of the facility.

23. The system of claim 22, wherein the rating factors further include healthfulness of the environment of the facility, competence of trainers utilized by the facility for assisting and guiding the users, and quality, quantity, and variety of exercise equipment available to the users.

24. The system of claim 23, wherein the rating factors further include availability of products and services supplied by the facility for use by the users in support of at least one of exercise and health goals of the users.

25. The system of claim 21, wherein the organization is further adapted to generate an overall rating for the facility, and wherein the overall rating is a function of the rating factors.

26. The system of claim 25, further comprising means for publishing the overall rating.

27. The system of claim 26, further comprising means for publishing the rating factors.

28. The system of claim 26, wherein publishing the overall rating includes publishing the overall rating on an Internet website.

29. The system of claim 28, wherein the Internet website is owned or controlled by the organization.

30. The system of claim 25, wherein the overall rating is an unweighted arithmetic average of the rating factors.

31. The system of claim 25, wherein the overall rating is a weighted arithmetic average of the rating factors.

32. The system of claim 31, wherein the rating factors include comradery experienced by users of the facility, and wherein said comradery has a higher weight than any other rating factor utilized for generating said overall rating.

33. The system of claim 31, wherein the at least one on-site inspection consists of a plurality of on-site inspections.

34. The system of claim 31, wherein the at least one on-site inspection includes an unscheduled inspection by the at least one inspector.

35. The system of claim 31, wherein the at least one inspector consists of a plurality of inspectors.

36. The system of claim 35, wherein the plurality of inspectors includes a male inspector and a female inspector.

37. The system of claim 21, wherein the at least one inspector has taken a training course pertinent to performing said inspecting.

38. The system of claim 37, wherein the training course was sponsored by the organization.

39. The system of claim 21, wherein the at least one inspector has passed an examination that tests knowledge of physical exercise, health, and dynamics of comradery.

40. The system of claim 21, wherein the at least one trained inspector is physically fit, has a physically fit appearance, and has passed a minimum strength test.
